(19) United States
(12) Patent Application Publication
(10) Pub. No.: US 2002/0136669 A1
(43) Pub. Date: Sep. 26, 2002

(54) Air filtering apparatus and methods fo using same

(76) Inventor: Federico Marques, Channel View, TX (US)

Correspondence Address: ROBERT W. STROZIER, SUITE 930, 2925 BRIARPARK DRIVE, HOUSTON, TX, 77042, US

(21) Appl. No.: 10/001,778

(22) Filed: Oct. 23, 2001

Related U.S. Application Data
(63) Continuation of application No. 09/178,978, filed on Oct. 26, 1998, now abandoned.

(51) Int. Cl. B01J 19/00; B32B 5/02; G05D 9/00; B32B 27/04; B32B 27/12; A62B 7/08

(52) U.S. Cl. 422/106; 422/120

(57) ABSTRACT

An air filter system is disclosed which utilizes a house plant growing in a standard plant growing device (pot) and a subsurface air withdrawal member positioned below the top surface of the growth media in which the plant is growing. The subsurface member has intake and outlet apertures where the outlet aperture is in fluid communication with a fan unit. The fan unit pulls air from the environment into and through the plant growing medium, into and through the subsurface member and into and out of the fan unit. As the air is pulled through the growth media the plant and associated micro-organisms remove airborne contaminants such as VOCs, pollens, dust and the like. The unit can also be operated in reverse where air is drawn into the fan unit and exhausted through the plant growth medium. Thus, any pot suitable for growing plants indoors can be converted into an air filter for upgrading the air quality of in open, closed or semi-closed environments.

### BACKGROUND OF THE INVENTION

1. Field of the Invention

This invention relates to an apparatus and methods for filtering air or other gases to remove airborne contaminants such as volatile organic compounds (VOCs) and other contaminants from the air or other gases especially in closed or semi-closed environments.

More particularly, this invention relates to apparatus and method for removing contaminants from air in closed or semi-closed environments where the apparatus includes an air filtering unit a portion of which is designed to be placed in a plant growth medium in a pot containing a living plant. The method involves pulling air from the closed or semi-closed environment into and through the plant growth media (preferably, a hydroponic or soil composition semi-permeable to air), into and through the subsurface portion of the filtering unit and exhausted back into the environment.

2. Description of the Related Art

Several devices claimed in U.S. Patents and written about in literature are known for utilizing plants and the microorganisms associated with growing plants to remove airborne contaminants from the air including VOCs. Such devices are taught in the following U.S. Pat. Nos. 4,732,591; 4,975,251; 5,078,972; 5,130,091; 5,180,552; 5,277,877; 5,397,382; 5,407,470; 5,433,923; and 5,631,015, incorporated herein by reference.

Although numerous devices have been constructed to utilize plants and the microorganisms that live in the growth medium of living plants for air purification, many of these devices are difficult to use and maintain and, generally, require specially designed pots into which a plant and growth medium is placed. Thus, there is a need in the art for a simple device that can be used with any standard plant container or pot designed for plants that can convert any standard plant in a container or pot into an air filtration device.

### SUMMARY OF THE INVENTION

The present invention provides a device which converts standard plant growing devices or pots into air filtering devices capable of removing airborne contaminants. The filtering devices of the present invention include a hollow subsurface element. The element includes an inlet aperture or opening preferably associated with a bottom surface, a side surface or both for fluid flow (preferably gas flow) into an interior of the element where the fluid is from a fluid source (preferably, an air or gas source). The element also includes an outlet aperture preferably associated with a top surface, side surface or both of the element for fluid (gas) flow out of the interior of the element. The element is designed to be placed in a pot containing growth medium and a living plant so that the inlet opening is below the surface (subsurface) of the growth medium.

The filtering device also includes an exhaust fan assembly in fluid communication with the at least one aperture associated with the top or side surface of the element. The exhaust fan assembly includes a fan, a power supply, associated electric or electronic control circuitry, an on/off switch and a housing having an interior for housing the fan and associated circuitry. The fan assembly further includes a first aperture designed to be in fluid communication with the at least one aperture associated with the top, bottom or side surface (or combination thereof) of the element for fluid flow (air or gas flow) from the element to the fan assembly interior. The fan unit also includes a second aperture for exhausting the fluid flow from the interior of the fan assembly to the air or gas source.

The present invention provides an apparatus including a plant growing device equipped with a hollow element. The element is designed to fit inside an interior of the plant growing device and to be covered by growth medium. The hollow element includes a plurality of inlet apertures associated with a bottom surface thereof for fluid flow into an interior of the element through the growth medium from an air source surrounding the growth medium. The element also includes at least one outlet aperture associated with a top or side surface thereof for fluid flow out of the interior of the element.

The apparatus also includes an exhaust fan unit or assembly in fluid communication with the at least one outlet aperture. The exhaust fan assembly is designed to attach to a top edge or side surface of the plant growing device. The exhaust fan assembly includes a fan, a power supply, associated electric circuitry, an on/off switch and a housing having an interior for housing the fan and associated circuitry. The housing also includes an inlet aperture in fluid communication with the at least one element outlet aperture for fluid flow from the element into the fan assembly interior and an outlet aperture for fluid flow from the interior of the fan assembly to the air source. Preferably, the fluid flow is standard air, but other gas mixtures can be used provided the gas mixture is not toxic to the plant or micro-organisms in the growth medium that are responsible for the filtration and decomposition processes.

The present invention provides an apparatus including a plant growing device having a growing plant, a growth medium and an airborne contaminant removal unit associated therewith, where the airborne contaminants include dust, pollen, mold spores, etc. The removal unit includes a subsurface hollow element designed to fit inside an interior of the plant growing device, to be covered by growth medium and not to substantially interfere with plant growth. The element includes a plurality of inlet apertures associated with its bottom surface for fluid flow into its interior from an outside air source and at least one outlet aperture associated with its top or side surface for fluid flow out of its interior.

The apparatus also provides an exhaust fan assembly designed to be in fluid communication with a subsurface hollow element and to attach to a top edge, side surface or bottom surface or some combination thereof of the plant growing device. The exhaust fan assembly includes a fan, a power supply, associated electronic circuitry, an on/off switch and a housing having an interior for housing the fan and associated circuitry. The housing includes an inlet aperture in fluid communication with the at least one element aperture for fluid flow from the element to the assembly and an outlet aperture for fluid flow from the assembly to the outside air. Additionally, the apparatus humidifies the air because the air that is exhausted by the exhaust fan is more humid than the air being pulled through the growth medium.

The present invention also provides a method for removing environmental contaminants such as VOCs in air or gas supplies where the method includes growing a plant in an apparatus described above where the air is pulled through the growth medium into the inlet apertures of the hollow element, through the hollow element and out through the element outlet into the fan assembly and out the fan assembly back into the air or gas supply. Airborne contaminants, i.e., such as pollen, dust, mold spores etc., are reduced through interactions with the growth medium, roots of the growing plant and microorganisms associated therewith. Additionally, the present invention provides a method of simultaneously removing environmental contaminants and humidifying the air.

### DESCRIPTION OF THE DRAWINGS

The invention can be better understood with reference to the following detailed description together with the appended illustrative drawings in which like elements may be numbered the same:

FIG. 1 is a cross-sectional view of an embodiment of an airborne contaminant removal system of this invention positioned in a plant growing device or pot;

FIGS. 2A-C are cross-sectional views of subsurface hollow elements of this invention;

FIGS. 3A-G are top views of subsurface hollow elements of this invention;

FIGS. 4A-I are cross-sectional views of subsurface hollow elements of this invention;

FIGS. 5A-D are bottom views of subsurface hollow elements of this invention;

FIG. 6 is a cross-sectional view of a fan assembly of this invention;

FIG. 7 is a cross-sectional view of a fan assembly of this invention;

FIG. 8 is a top assembly view of an electronic control unit of this invention; and

FIG. 9 is a top side trace view of an electronic control unit of this invention.

### DETAILED DESCRIPTION OF THE INVENTION

The inventor has found that an efficient and cost effective device can be constructed which converts any standard plant growing container or pot into a device designed to remove environmental contaminants such as VOCs, pollen, dust, smoke, smog, or the like from breathing air supplies such as the air in a house or other dwellings, buildings, submarines, air craft, space craft or any other air supply used to support animal life, including human life, or where environmental contaminated air cannot be tolerated.

The present invention is directed to an air circulating system which includes a subsurface air flow element in fluid communication with an exhaust fan assembly and an outside air source. The circulating system is designed to work in conjunction with a plant growing device housing a growing plant. The subsurface element can be of any size and shape, but is preferably shaped and sized to fit within a plant growing container, and to be covered partially, substantially or completely with the growth medium and not to substantially interfere with plant growth. The element also includes a plurality of intake (inlet) apertures for supporting air flow through the growth medium and into an interior or interior chamber of the element. The intake apertures are preferably associated with a bottom surface or a side surface or both the bottom and side surfaces of the element. The element also includes at least one exhaust (outlet) aperture associated with either a top surface, the bottom surface, the side surface or any combination of these element surfaces.

The element should be positioned in the growth medium so that it does not substantially interfere with plant growth and should be positioned so that the water level in the plant container generally is not capable of filling a substantial portion of the interior chamber of the element. This operational positioning criteria is necessary to ensure that air is circulated through the apparatus and not water.

Preferably, a pot is selected and filled with a two layer growth medium, a bottom layer and a top layer. The bottom or lower layer occupies from about 60% to about 90% by volume of the pot and comprises of a hydroponic growth medium such as Perlite. The subsurface element is placed on top of the hydroponic growth medium layer with the intake aperture directed down. The top or upper layer occupies from about 40% to about 10% by volume of the pot and comprising a filter medium which covers all or part of the subsurface element. The plant, of course, if also placed in the pot so that the air flow through the growth medium, both layers thereof, brings the air in contact with the plants root system and the microbes in the growth medium. The particularly preferred volume amount of the bottom layer is between about 65% and 85%, with 70% to 80% being especially preferred. Of course, the volume amount of the upper layer is adjusted so that the growth medium volume sums to 100% by volume It should be recognized that 100% is based on the total volume amount of soil added to the pot and is not necessarily the amount of soil to fill the pot with a growing plant all the way to the top of the pot. Thus, the 100% may refer to some fraction of the pots internal volume or the some fraction of the volume of an internal pot liner.

The exhaust fan assembly is in fluid communication with the subsurface element interior and provides the driving force for supporting fluid flow into and out of the interior. The exhaust fan assembly comprises an electric fan, a power supply for supplying electrical power to the fan, an on/off switch for turning the fan on and off and associated electronic circuitry for supporting electric communication between the fan, the power supply and the switch. The assembly further comprises a housing having an intake aperture in fluid communication with the exhaust aperture of the interior and an exhaust aperture in fluid communication with outside air. The housing is designed to contain the fan and electronic control circuitry.

The system basically operates by pulling fluid, preferably outside air, through a portion of a growth medium covering the subsurface element into its interior chamber through intake holes, orifices, perforations, apertures, slots, slits, semi-permeable membranes, or combination thereof therein. The air is then drawn through the element through at least one exhaust hole, port, aperture, slot or orifice in fluid communication with the fan assembly, into the fan assembly and back into the outside air. Preferably, the growth medium must be semi-permeable to air flow and not prone to compacting during long duration of plant growth and watering. As the air flows through the growth medium it is cleansed of environmental contaminants. Cleansing results from the VOCs being absorbed or adsorbed into or onto the growth medium and then decomposed either by the roots of the growing plant or by microorganisms living in the growth medium including microorganisms associated with the roots of the growing plant; while solid or particulate airborne contaminants are deposited in growth medium. Generally, VOCs or other pollutants or contaminants are absorbed into the filter or growth medium. Extensive microbial cultures are found in the rhizosphere around the growing plants and their roots. These microbes or micro-organisms then metabolize the contaminants and convert them into harmless or less harmful compounds, such as carbon dioxide, nitrogen, simple acids or the like. Some are adsorbed by the plant and oxidized internally to a carbon source for biomass.

Of course, it should be recognized that the term fluid flow for the purposes of this invention means the flow of gases which can have varying degrees of water vapor (varying levels of humidity) associated therewith as well as varying concentrations of environmental contaminants such as VOCs, pollen, dust, spores, or other airborne contaminants. It should also be recognized that although the fluid flow preferably goes from the outside air into the subsurface interior and out the fan assembly and back out into the outside air. The apparatus can also be operated in reverse so that the air flows from the outside air, into the fan assembly, from the fan assembly into the interior, from the interior into the growth medium and through the growth medium back to outside air.

It should also be recognized that as the air flows through the growth medium, it will tend to pick up moisture in the growth medium which can result in growth medium drying. To prevent growth medium drying (which can result in plant death when not properly attended), the apparatus of the present invention preferably also include a growth medium moisture monitor and associated electronic circuitry that will turn the fan off when the moisture content of the growth medium falls below some predetermined moisture content. The circuitry will also include an alerting device to alert a user that the moisture content of the growth medium has fallen below a predetermined moisture content. The alerting device can either be a light that goes from an off condition to an on condition when the monitor changes state, a sound generator that goes from an off condition to an on condition when the monitor changes state, or any other similar alerting device or a combination of such devices. Once water has been added to the plant growing device or container and the moisture content of the growth medium is above the shut off threshold, the circuitry can automatically turn the fan back on. Otherwise, the user will have to turn or switch the fan on/off switch from the off position to the on position manually.

Growth media suitable for this present invention include any growth media having an appropriate air permeability to support the air flow indicated herein. Although standard soils can be used with the present invention, such soils tend to compact to an extent that the soil no longer allows sufficient air flow through the soil and into the subsurface element of the air filtration system of the present invention. Preferred growth media for use in the present invention are those media that aid in plant growth, aeration and water retention. Such media include hydroponic media or semi-permeable growth media such as particles of expanded clay, peat, zeolites, fugacites, mulinites, scoria, pumice, perlite soil enhances such as SoilPro, filter media such as charcoal, activated carbon, high surface area ion exchange resins, or other aerated soil alone, in combination or in combination with other standard soil compositions. Such soil compositions should have a pressure drop between the soil surface and the intake orifices of the subsurface element of at most about 10 psi (0 to about 10 psi), preferably at most about 5 psi (0 to about 5 psi) and particularly preferred at most about 1 psi (0 to about 1 psi).

Preferred growth media are compositions comprising 0 to 100 wt. % activated carbon, 0 to 100 wt. % zeolite, 0 to 100 wt. % perlite or soilpro (expanded clays) and 0 to 100 wt. % standard soil (ordinary dirt). Particularly preferred growth media comprise about 5 to about 95 wt. % activated carbon, about 5 to about 95 wt. % zeolite, about 5 to about 95 wt. % Perlite or SoilPro (expanded clays) and about 5 to about 95 wt. % soil. Especially preferred growth media comprise about 10 to about 50 wt. % activated carbon, about 10 to about 50 wt. % zeolite, about 10 to about 50 wt. % Perlite or SoilPro (expanded clays) and about 5 to about 25 wt. % soil. And most preferred growth media comprise about 20 to about 40 wt. % activated carbon, about 20 to about 40 wt. % zeolite, about 20 to about 40 wt. % Perlite or SoilPro (expanded clays) and about 5 to about 15 wt. % soil.

Plants suitable for use in the apparatus of this invention include any plant that will grow adequately well in an closed or semi-closed environment such as standard house plants. But common tropical house plants are preferred, especially those with enhanced ability to remove organic contaminants from the air. Typical such houseplants include: weeping fig (Ficus benjamina), peace lily (Spathiphyllum sp.), areca palm (Chrysalidocarpus lutescens), corn plant (Dracaena fragrans “Massangeana”), lady palm (Rhapis excelsa), Warneckei (Dracaena deremensis “Warneckei”), dumb cane (Dieffenbachia “Exotica compacta”), Ficus alli'(Ficus alli'), dumb cane (Dieffenbachia camille), elephant ear philodendron (Philodendron domesticum), golden pathos (Epipremnum aureum), arrowhead vine (Syngonium podophyllum), snake plant (Sansevieria trifasciata “Laurentii”), croton (Codiaeum variegatum) and umbrella grass (Cyperus alternifolius) and other plants known or discovered to have special efficiency for this purpose. Of course, any plant capable of growing in closed or semi-closed environments will have some beneficial effect.

The fans or air pumps suitable in this invention include so-called squirrel cage fans, propeller fans, impeller fans, pumps or any other apparatus that can be used to draw air from a room into a subsurface element and exhausted back into the room. Generally, the fan or circulation device should pull at a rate of between about 1 and 500 ft³/min., preferably, between about 10 and 100 ft³/min., particularly preferred, between about 5 and 50 ft³/min., especially preferred between about 10 and 30 ft³/min. and most preferred, between about 10 and 20 ft³/min.

Referring now to the figures, the invention will be illustrated by reference to several preferred embodiments of the apparatus of the present invention. It should be understood that the size and shape of these preferred embodiments can be augmented in a number of ways and still be within the scope of the present invention.

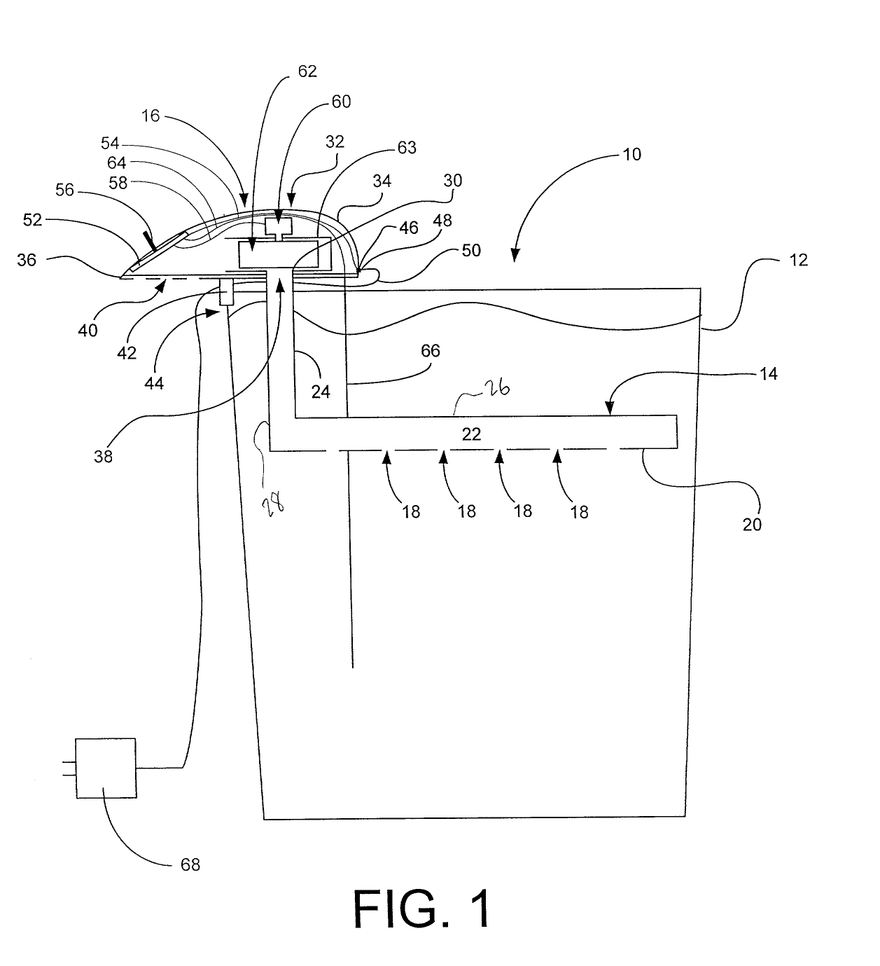

Referring now to FIG. 1, a first embodiment of the apparatus of the present invention, generally 10, is shown to include a plant growing container 12, a hollow, subsurface air flow element 14 and an exhaust fan unit 16. The element 14 includes a plurality of intake apertures or holes 18 in its bottom surface 20. The intake apertures 18 are designed to allow air to flow into or out of an interior chamber 22 of the element 14 depending on whether the apparatus is operated in a forward (normal) or reverse condition.

The element 14 also includes an exhaust conduit 24 attached to or integral with the element 14 and extending from its top 26 or side 28. The conduit 24 connects at its distal end 30 to the fan unit 16. If the conduit or tube is not integral with the element, then the conduit will fit into an exhaust aperture associated with the top or side of the element where the exhaust aperture can include a joint or coupling to receive an end of the conduit as shown more fully herein. If the conduit is not integral with (i.e., one continuous piece of material), then the conduit can be simply attached to the element or affixed to the element by any standard technique including fastening, bonding, melt flowing, or the like.

The fan unit 16 includes a housing 32 having a top section 34 and a bottom section 36. The bottom section 36 includes an intake aperture 38 designed to engage the tube 24 at its distal end 30 placing the fan unit 16 in fluid communication with the element 14. The intake aperture 38 can of course include a coupling or joint into which the distal end 30 of the conduit 24 fits. The bottom 36 also includes exhaust apertures 40 in fluid communication with the outside air. The bottom 36 may optionally includes a clamping device 42 for engaging a portion 44 of the container 12. Preferably, the fan unit 16 merely rests on the conduit 24 and does not need to be clamped to the side of the pot. The top 34 of the fan unit 16 includes a power cord aperture and fitting 46 through which a first end 48 of a power cord 50 is inserted.

The power cord 50 provides power to an electronic control unit 52 through electric wires 54. The electronic control unit 52 can be attached to an interior surface 35 of the top 34 by any process well-known in the art such as fastening, gluing, anchoring, etc. The electronic control unit 52 includes an on/off switch 56. The electronic control unit 52 also includes electric wires 58 to a fan motor 60 operatively connected to or associated with a fan 62 located within a fan holder or housing 63. The electronic control unit 52 may further include electric wires 64 to a moisture sensor 66. Additionally, the electronic control unit can include a display, a sound generator, lights or other informational visualization devices so that the user can be advised as to the operating conditions of the apparatus of the present invention.

Although the fan unit 16 can operate using any type of power source including any AC or DC power source. The fan unit 16 of the present invention preferably uses a DC power source where the DC power is provided by a AC to DC converter 68 that plugs into any standard 120V or 240V electrical outlet. Of course, preferably, the outlet source in the USA is a 120V outlet, while in other countries, it will generally be a 220V outlet. The DC supply is preferably an 8V to 12V system.

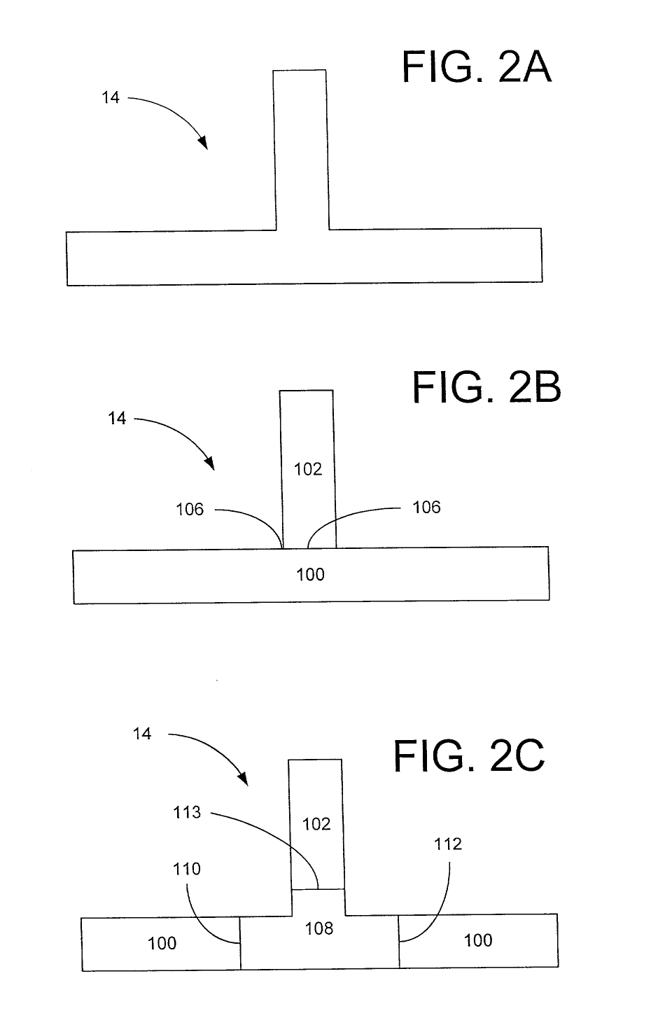

Referring now to FIGS. 2A-C, front views of several embodiments of the element 14 of the present invention are shown. In FIG. 2A, the element 14 comprises a unitary or integral piece of material. In FIG. 2B, the element 14 includes an air flow member 100 and a hollow conduit 102 where a first or proximal end 104 of the conduit 102 fixedly or detactably engages the element 14 at an exhaust aperture 106. The element can also include a joint or coupling (not shown) associated with exhaust aperture for connecting the conduit to the element.

In FIG. 2C, the element 14 includes an air flow member 100, a hollow T joint 108 and a conduit 102. The T joint 108 interconnects a first end 110, and a second end 112 of the element 14 and a proximal end 113 of the conduit 102 so that air entering the element 14 through apertures 18 in the air flow member 100 flow into the T joint 108 and into the conduit 102 on its way to the exhaust fan unit 16.

Of course, it should be recognized that the element 14 can be constructed as a single unit or out of a series of elements that interconnect to form a subsurface air flow passageway for moving air into and through the growth medium, into and through the element and into and out of the fan unit. Thus, the element 14 could comprise a plurality of small interconnectable hollow pieces where the interconnected assembly has at least one aperture on its bottom side to allow air to be drawn through the growth medium and into the assembly for exhausting from the fan unit.

It should be recognized that the unit could also be run in reverse, i.e., blowing air into the media through the orifices in the bottom of the element and allowed to exist on its own by diffusing through the air permeable plant growing media.

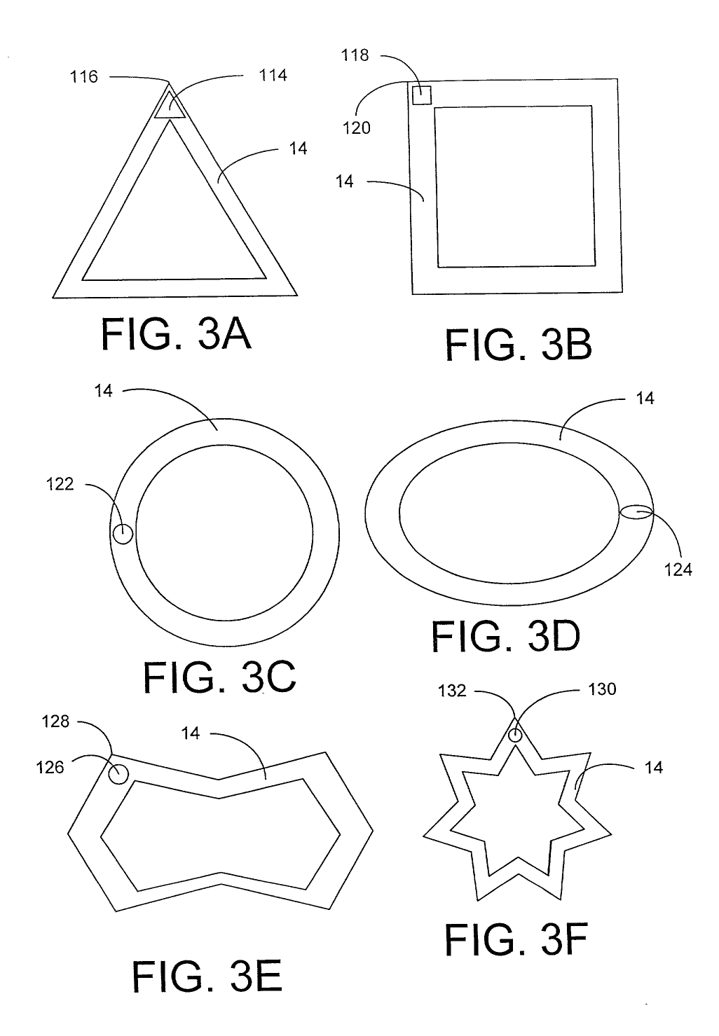

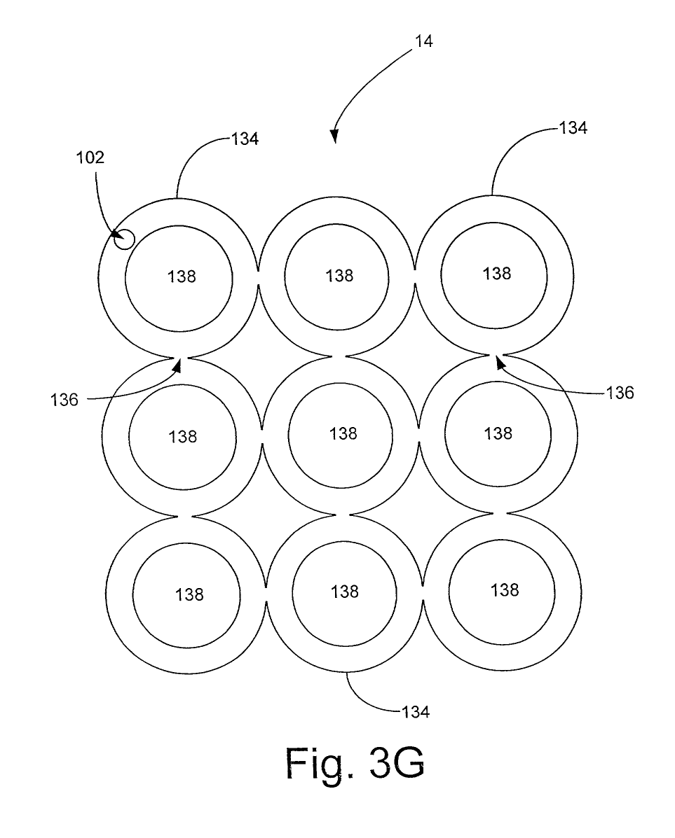

Referring now to FIGS. 3A-F, several possible shapes of the element 14 are shown in a top plan view. In FIG. 3A, the element 14 has a triangular shaped tube having a triangular aperture 114 associated with one vertex 116 into which the conduit 24 (not shown) fits or from which the conduit 24 extends. In FIG. 3B, the element 14 has a square shaped tube (more generally a quadralateral) having a quadralateral shaped aperture 118 associated with one vertex 120 into which the conduit 24 (not shown) fits or from which the conduit 24 extends. In FIG. 3C, the element 14 has a torus shape having a circular shaped aperture 122 associated therewith into which the conduit 24 (not shown) fits or from which the conduit 24 extends. In FIG. 3D, the element 14 has an oval shaped torus having an oval shaped aperture 124 associated therewith into which the conduit 24 (not shown) fits or from which the conduit 24 extends. In FIG. 3E, the element 14 has a bi-pentangle shape having a circular shaped aperture 126 associated with one vertex 128 into which the conduit 24 (not shown) fits or from which the conduit 24 extends. In FIG. 3F, the element 14 has a seven pointed star shaped tube having an circular shaped aperture 130 associated with one vertex 132 into which the conduit 24 (not shown) fits or from which the conduit 24 extends.

Of course, it should be recognized that the element 14 can be of any shape provided that it fits within the plant growing device (pot) and allows roots to grow below or at least does not adversely affect plant growth and ultimate air quality enhancement. Moreover, the element 14 can comprise a plurality of interconnected small hollow forms 134 that interconnect at interconnections 136 to form a completed element 14 having passages 138 therethrough such as a plurality of interconnected units of FIG. 3C as shown in FIG. 3G. Of course, the interconnected composite elements can include any mixture of small interconnectable hollow forms provided that there is at least one, and preferably only one, exhaust aperture connected to or integral with a conduit for attachment to the fan unit.

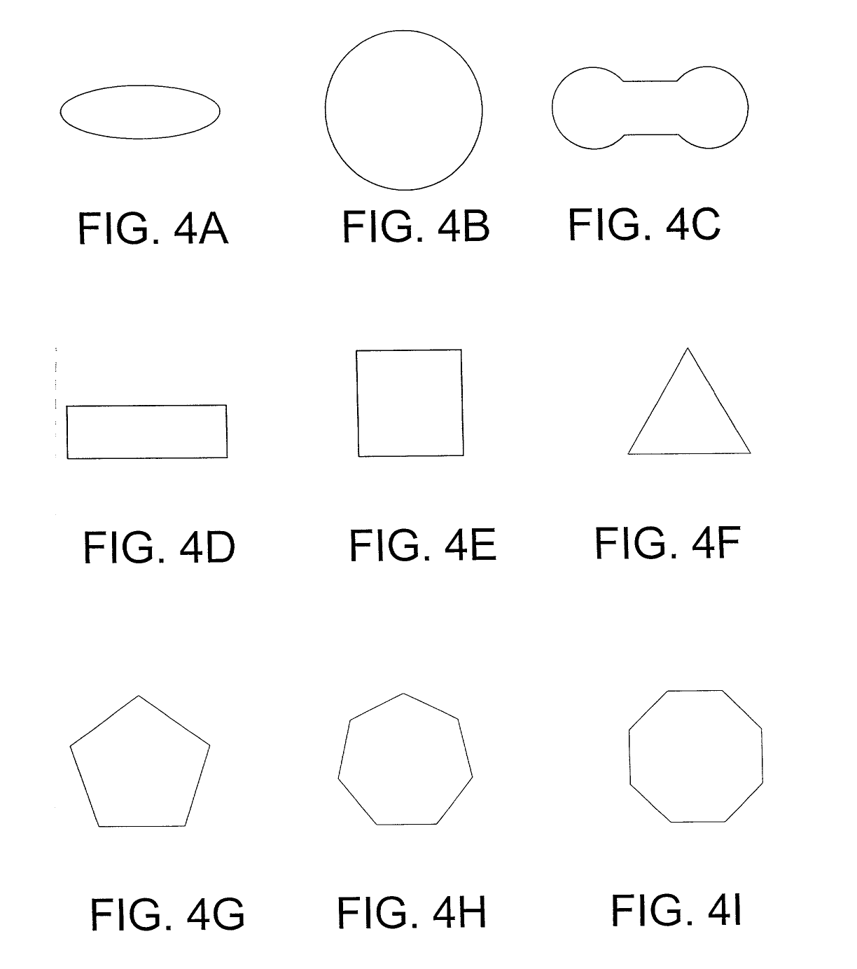

Referring to FIGS. 4A-I, several cross-sectional shapes of the elements 14 of the present invention are shown. The cross-sectional shape can be an oval (FIG. 4A), a circle (FIG. 4B), a dumbbell (FIG. 4C), a rectangle (FIG. 4D), a square (FIG. 4E), a triangle (FIG. 4F), a pentagon (FIG. 4G), a heptagon (FIG. 4H), a octagon (FIG. 4I) or the like. Of course, the airflow element of the present invention can be of any shape or any mixture or combination of shapes. The element may also include internal baffles or related air flow regulation devices so that the element will pull air preferably equally from all of the intake apertures in any desired manner, but preferable substantially equally from all intake apertures.

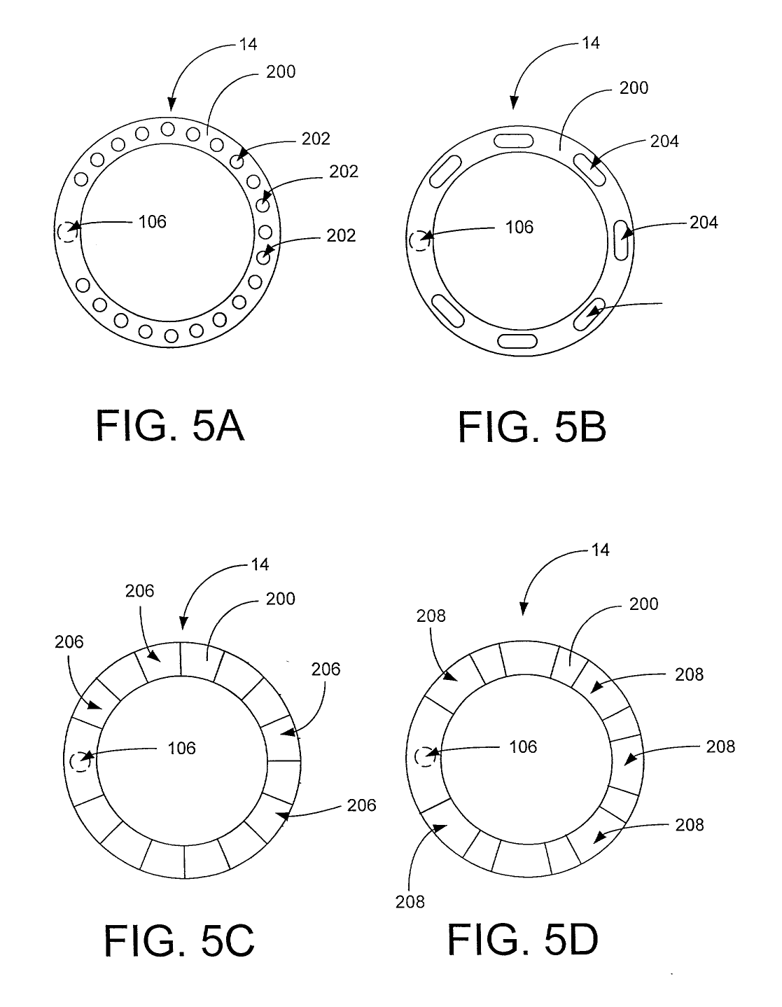

Referring now to FIGS. 5A-D, several embodiments of a bottom surface 200 of the element 14 are shown for the purposes of illustrating different types and configurations of intake apertures. In FIG. 5A, the bottom surface 200 includes a plurality of circular intake apertures or holes 202. In FIG. 5B, the bottom surface 200 includes a plurality of oval intake apertures or holes 204. In FIG. 5C, the bottom surface 200 includes a plurality of slots 206. In FIG. 5D, the bottom surface 200 includes a plurality of large slots 208. Of course, the size, shape and distribution of holes or apertures in the elements 14 of the present invention can be of any desired shape, any desired size and any desired distribution and could in fact have a hollow bottom.

The apertures can be a screened by a mesh such as copper or brass wire mesh or other air permeable device that does not impede air flow, but tends to repel or prevent root growth into the interior of the subsurface air flow elements of the present invention. However, generally roots will not grow into areas capable of drying the roots of the plant.

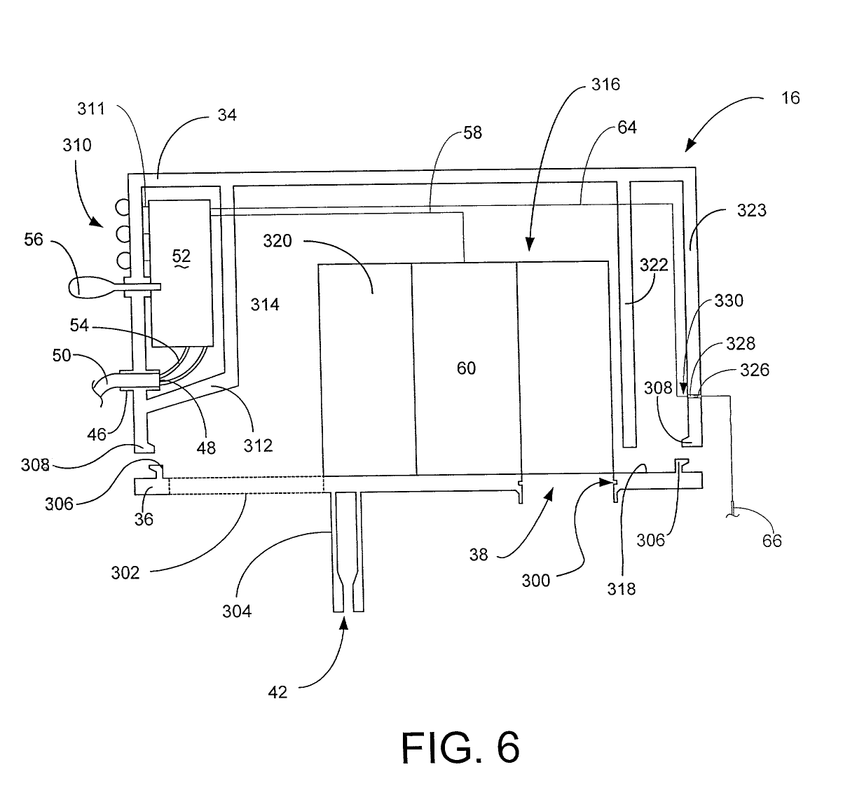

Referring now to FIG. 6, another embodiment of the fan or blower unit 16 is shown to include a top section 34 and a bottom 36. The bottom section 36 includes an intake 38, an intake snap fitting 300 and a screen 302 which acts as the exhaust perforation or apertures for the blower unit 16. The bottom 36 can also include an option clamp 42 for connecting to a plant growing device such as a pot. The clamp 42 is shown to include two vertically extending members 304 that form a clip type clamp which is designed to clip onto the wall of a plant growing device such as a pot. Of course, any clamp or clamping means can be used as well to fasten or attach the fan unit to the pot.

The bottom 36 also include a clip ridge 306 for detachably engaging the top section 34. The clip ridge 306 is designed to detachably engage an interior lip 308 of the top 34. Of course, the top and bottom sections can attach to each other in a variety of different ways including threaded connections, tongue and groove, twist and lock, clip rings, pins, screws or any other suitable attachment means well known in the art. The sections can also the bonded together either adhesively or by melt flow techniques. The seal can be, and preferably is, water tight, to ensure against water damage to the electronics control unit and wiring.

The top section 34 includes an electronic or electrical control unit 52 having control circuitry and an integrated circuit or chip (IC) which acts to control the function of the fan unit as described in more detail herein and an on/off switch 56 and indicator lights 310 connected by wires 311 to the unit 52. The indicator lights 310 can be used to advise the user of the current state of the system such as moisture content of the growth medium, power on or off, fan on or off, motor malfunction, fan malfunction, reduced air flow or the like. The electrical unit 52 can also include sound generating devices to work in conjunction with the lights to advise the user on the condition of the system. Surrounding the electrical unit 52 is an optional electric housing 312 which serves to isolate the electronics control unit 52 and to reduce an interior volume 314 of the top 34. The top 34 also includes an electrical cord 50 attaching at fitting 46 at its distal end 48 out of which extend DC power and ground wires 54 which supplies DC power to the unit 52.

The top 34 can optionally include a vertical wall 316 which in conjunction with the electric housing 312 works to reduce the interior volume 314 of the unit 16. The unit 16 also includes a blower 318 fixedly attached to a top surface 320 of the bottom 36. The blower 316 includes a motor 60 which causes a outer blower fan unit 322 to undergo rotary motion. The blower 316 is electrically connected to the electronics control unit 52 by wires 58.

The bottom section 36 also includes a moisture sensor 66 electrically connected to electronics control unit 52 by wires 64. The sensor 66 attaches to a side 323 at a fitting 324 which has an electrical connector 326 associated therewith. The electrical connector 326 is designed to engage an electrical connector 328 at a distal end 330 of the wires 64. Although the unit 16 was shown as an flattened tear-drop in FIG. 1 and here as a rectangular solid, the unit 16 can be of any shape and size. Generally, the unit will be sized to accommodate the size and shape of the plant pot to which it is to be attached; provided that the device is capable of pulling air through the growth medium at an acceptable rate so that the system is capable of purifying the air of airborne contaminants at an acceptable removal rate as discussed above.

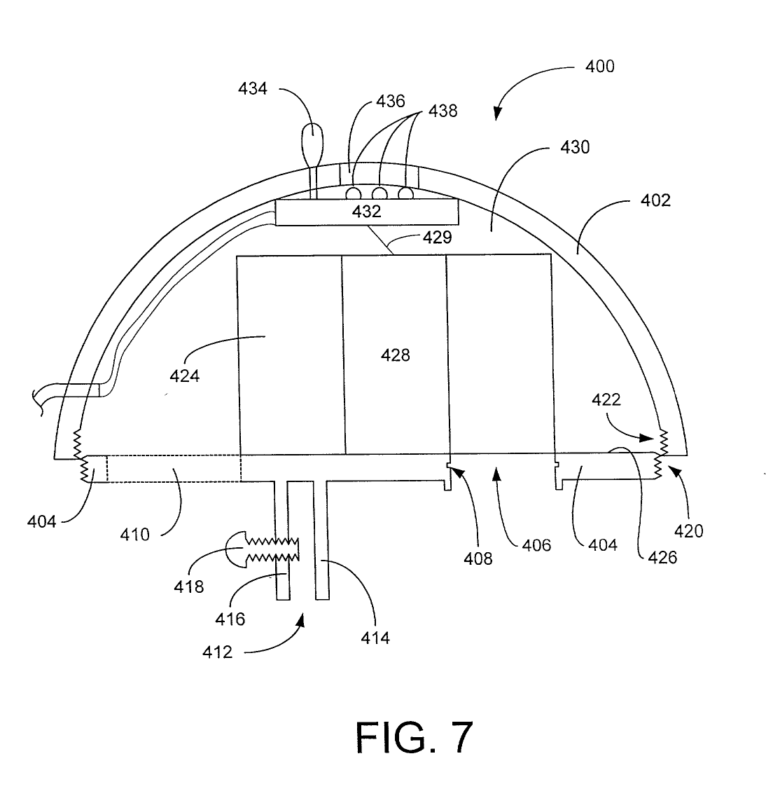

Referring now to FIG. 7, another embodiment of a fan unit 400 of this invention is shown to include a top section 402 and a bottom section 404. The bottom section 404 includes an intake 406, an optional intake snap fitting 408 (friction fits are preferred) and a screen 410 which acts as the exhaust outlet for the fan unit 400. The bottom 404 can also optionally include a clamp 412 for connecting the fan unit 400 to a plant growing device such as a pot (not shown). The clamp 412 includes an interior vertical member 414, an exterior vertical member 416 and a threaded screw member 418 which engages a threaded hole in the exterior vertical member 416 for securing the unit to the pot. Preferably, no clamp is included with the unit because the fan unit can be supported adequately on top of the subsurface member exhaust conduit. The bottom 404 also includes a continuous threaded edge 420 for detachably engaging a threaded bottom portion 422 of the top 402.

The top 402 also includes a blower 424 fixedly attached to a top surface 426 of the bottom 404. The blower 424 includes a motor 428 which causes the blower 424 to undergo rotary motion. As seen in FIG. 7, the motor 428 is an integral part of the blower 424. Attached to the top 402 is an electronic control unit 432 which is electrically connected to the blower motor 428 by wires 429. The electronic control unit or circuitry 432 includes control circuitry and an integrated circuit or chip (IC) which acts to control the function of the fan unit as described in more detail herein. The unit 432 also includes a manual on/off switch 434, and indicator lights 436. The indicator lights 436 are viewable through and a window 438 in the top 402.

The indicator lights 436 can be used to advise the user of the current state of the system such as moisture content of the growth medium, power on or off, fan on or off, motor malfunction, fan malfunction, reduced air flow or the like. The electrical control unit 432 can also include sound generating devices to work in conjunction with the lights to advise the user on the condition of the system. The electrical control unit 432 is optionally encased in an insulating material which surrounds the control unit 432 and serves to isolate it from water or water vapor. The electric control unit 432 also includes a photo transistor that senses light and signals the control circuitry or IC to turn the unit off. This preferred operating setting is to designed to turn the unit off during night time hours so that the unit will not wake the operator up during the night due to low water or any other alert condition. Additionally, the entire unit can include a water level indicator so that the operator will know how much water is needed for proper plant maintenance.

The blower unit 400 also includes an electrical cord 50 for supplying DC power to the circuitry 432 via wires 54. The blower unit 400 can also include various sensors such as the moisture sensor 66 of FIG. 6. The unit 400 is shown as a generally hemispherical unit with the on/off switch and light indicators disposed on the top of the unit.

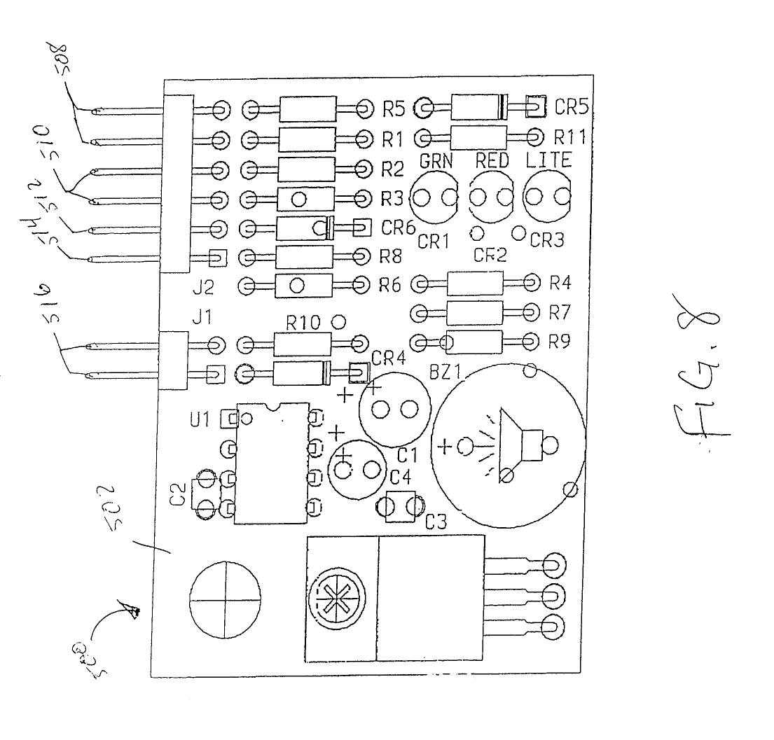

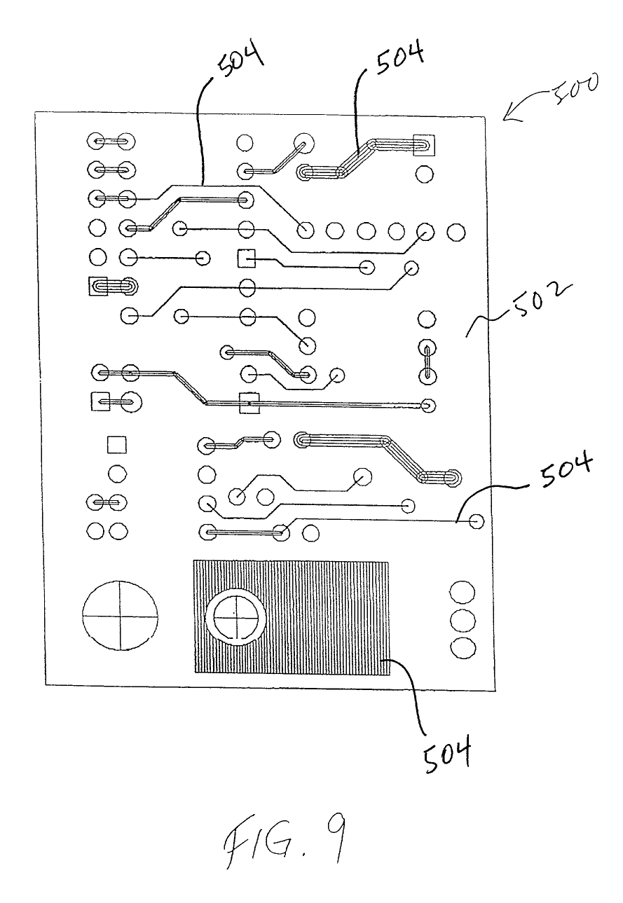

Referring now to FIGS. 8 and 9, a preferred embodiment of an electrical unit 500 is a small circuit board 502 which includes the following list of components: resistors R1 through R11; diodes CR1 through CR6; electrolytic capacitors C1 through C4; an integrated circuit U1; a buzzer BZ1 and a transistor Q1 laid-out as shown in FIG. 8 in accordance with wiring traces 504 shown in FIG. 9.

CR3 is a photo-transistor which provides information to the control circuitry so that the unit is turned off at night. Preferably, the unit is designed to turn off at night as a convenience so that during the night time hours, the unit will not be dehydrating the growth media which alerts the operator by an alarm of some type. Preferably, the photo-transistor is active in the IR region of the electromagnetic spectrum. Certain photo-transistors may also require an additional resistors to ensure that the device has its full range in the circuit design as shown.

The board 502 also includes a plurality of pins 506 for making connection to external devices. The pins 506 include two probe pins 508 for the moisture sensor, two switch pins 510 for the on/off switch, a 12V pin 512 and a ground pin 514 for making connection with the DC power supply, and two motor pins 516 for making connection to the blower motor.

The components have the following specifications:

| Component | Specs |
|---|---|
| R1 | 100 KΩ |
| R2 | 150 Ω |
| R3 | 10 KΩ |
| R4 | 10 KΩ |
| R5 | 1 MΩ |
| R6 | 1 KΩ |
| R7 | 100 KΩ |
| R8 | 220 Ω |
| R9 | 470 KΩ |
| R10 | 680 Ω |
| R11 | 470 KΩ |
| CR1 | Green LED |
| CR2 | Red blinking LED |
| CR3 | Photo Transistor |
| CR4 | Damping 600 V |
| CR5 | Zener 9 V |
| CR6 | Zener 5.2 V |
| C1 | 220 μF |
| C2 | 1 μF |
| C3 | 1 μF |
| C4 | 220 μF |
| IC | LM1458 Dual opamp |
| BZ1 | 4.2 KHz piezoelectric |
| Q1 | D313 NPN switching |

Although FIGS. 8 and 9 show a preferred circuit board lay out for the electronic unit of the present invention, it should be recognized by one of ordinary skill in the art that other board lay outs that allow the fan or blower unit to operate in accord with the requirements of this invention will work equally well.

### EXAMPLES

The following examples are include for the sake of completeness of disclosure and to illustrate the methods of making the compositions and composites of the present invention as well as to present certain characteristics of the compositions, but in no way are these examples included for the sake of limiting the scope or teaching of this disclosure.

### Example 1

This examples illustrates the removal efficiency of an apparatus of the present invention compared to a blank and a room having a turned off unit within.

An office room of 1500 ft³ was sampled continuously using an air sampling pump. Samples were removed for GC/MS analysis at the start of each test and at 1, 4 and 8 hours. All samples were analyzed by GC/MS (gas chromatography, GC, to separate the components and mass spectrometry, MS, to identify the components) using approved EPA protocols. All measurements are reported in mg/m³.

A blank was run to determine the background concentrations of various contaminants over the eight hour test period, the Blank test. The analytical data associated with the Blank test are shown in Table 1. A unit of the present invention was then placed in the room and a cigarette was then lit and allowed to bum out in the sealed room, the Control test. The data for the Control test are presented in Table 2. Next, the unit of the present invention was turned on and the unit had a flow of 2 ft³/min. Samples were taken in an analogous manner as stated above and the data from the Unit test are presented in Table 3.

TABLE 1
Blank Data

| | | | | | Avg. Value | % Removal |
|---|---|---|---|---|---|---|
| Blank | Start | 1 Hour | 4 Hours | 8 Hours | (0-4 hrs) | 8 hrs |
| Methylene Chloride | 1623.0 | 1056.0 | 776.0 | 518.0 | 1151.7 | N/A |
| Acetone | 499.0 | 484.0 | 475.0 | 345.0 | 486.0 | N/A |
| Chloroform | 113.0 | 50.0 | 40.0 | 19.0 | 67.7 | N/A |
| 1,2-Dichloroethane | 6.0 | 0.0 | 1.0 | 0.0 | 2.3 | N/A |
| 2-Butanone | 812.0 | 912.0 | 203.0 | 292.0 | 642.3 | N/A |
| 1,1,1- | 7.0 | 2.0 | 1.0 | 2.0 | 3.3 | N/A |
| Trichloroethane | | | | | | |
| Benzene | 3.0 | 2.0 | 3.0 | 3.0 | 2.7 | N/A |
| Trichloroethane | 2.0 | 0.0 | 1.0 | 2.0 | 1.0 | N/A |
| 1,1,2- | 4.0 | 10. | 0.0 | 0.0 | 1.7 | N/A |
| Trichloroethane | | | | | | |
| Toluene | 17.0 | 15.0 | 6.0 | 9.0 | 12.7 | N/A |
| Ethylbenzene | 10.0 | 7.0 | 5.0 | 5.0 | 7.3 | N/A |
| Total VOCs | 3096.0 | 2529.0 | 1511.0 | 1195.0 | 2378.7 | N/A |
| Particulates | 120.0 | 48.0 | 73.0 | 80.0 | 80.3 | N/A |

TABLE 2
Control Data

| | | | | | Avg. Value | % Removal |
|---|---|---|---|---|---|---|
| Blank | Start | 1 Hour | 4 Hours | 8 Hours | (0-4 hrs) | 8 hrs |
| Methylene Chloride | 2331.0 | 654.6 | 1485.5 | 2342.0 | 1490.0 | −57.2 |
| Acetone | 1198.0 | 850.2 | 773.2 | 217.9 | 940.5 | 76.8 |
| Chloroform | 100.7 | 34.8 | 136.0 | 17.9 | 90.5 | 80.2 |
| 1,2-Dichloroethane | 20.3 | 0.0 | 12.2 | 0.0 | 10.8 | 100.0 |
| 2-Butanone | 1256.3 | 575.7 | 22.0 | 283.5 | 618.0 | 54.1 |
| 1,1,1- | 0.0 | 2.4 | 0.0 | 0.0 | 0.8 | 100.0 |
| Trichloroethane | | | | | | |
| Benzene | 5.7 | 0.8 | 2.7 | 0.8 | 3.1 | 73.9 |
| Trichloroethane | 0.0 | 0.0 | 0.0 | 0.0 | 0.0 | 0.0 |
| 1,1,2- | 0.0 | 0.0 | 0.0 | 0.0 | 0.0 | 0.0 |
| Trichloroethane | | | | | | |
| Toluene | 20.0 | 940.0 | 1120.0 | 450.0 | 693.3 | 35.1 |
| Ethylbenzene | 5.7 | 3.6 | 1.7 | 0.5 | 3.7 | 86.4 |
| Total VOCs | 4937.7 | 3062.1 | 3552.3 | 3312.6 | 3850.7 | 14.0 |
| Particulates | 3500.0 | 4200.0 | 2940.0 | 2330.0 | 3546.7 | 34.3 |

TABLE 3
Unit Data

| | | | | | Avg. Value | % Removal |
|---|---|---|---|---|---|---|
| Blank | Start | 1 Hour | 4 Hours | 8 Hours | (0-4 hrs) | 8 hrs |
| Methylene Chloride | 4370.5 | 3058.5 | 2437.3 | 807.0 | 3288.8 | 75.5 |
| Acetone | 849.5 | 0.0 | 625.0 | 389.0 | 491.5 | 20.9 |
| Chloroform | 67.8 | 1062.2 | 382.4 | 27.4 | 504.1 | 94.6 |
| 1,2-Dichloroethane | 0.0 | 81.2 | 5.8 | 0.0 | 29.0 | 100.0 |
| 2-Butanone | 926.8 | 1696.8 | 0.0 | 286.7 | 874.5 | 67.2 |
| 1,1,1- | 0.0 | 112.5 | 0.0 | 0.0 | 37.5 | 100.0 |
| Trichloroethane | | | | | | |
| Benzene | 1.8 | 221.3 | 8.6 | 2.6 | 77.2 | 96.6 |
| Trichloroethane | 0.0 | 240.1 | 12.1 | 1.8 | 84.1 | 97.9 |
| 1,1,2- | 0.0 | 260.3 | 6.5 | 0.0 | 88.9 | 100.0 |
| Trichloroethane | | | | | | |
| Toluene | 19.3 | 438.0 | 69.8 | 6.2 | 509.0 | 98.8 |
| Ethylbenzene | 0.5 | 87.3 | 9.7 | 3.0 | 32.5 | 90.8 |
| Total VOCs | 6236.2 | 8258.2 | 3557.2 | 1523.7 | 6017.2 | 74.7 |
| Particulates | 3810.0 | 4190.0 | 2070.0 | 1920.0 | 3356.7 | 42.8 |

It is clear from the data presented in Tables 1-3, that the unit of the present invention is effective in reducing both VOCs and particulate matter over an eight hour time frame.

Although the invention has been disclosed with reference to its preferred embodiments, from reading this description those of skill in the art may appreciate changes and modification that may be made which do not depart from the scope and spirit of the invention as described above and claimed hereafter.

We claim:

1. A method comprising the steps of:
(A) pulling gas from a space into a gas filtering system comprising:
(i) a plant growing device including:
(1) a growth medium;
(2) a plant growing in the medium;
(ii) a subsurface member including:
(1) a first gas inlet for pulling the gas into the member and through the medium; and
(2) a first gas outlet for discharging the gas from the member;
(iii) a fan unit including:
(1) a second gas inlet in fluid communication with the first gas outlet; and
(2) a second gas outlet for discharging the gas into the space;
(B) filtering the gas of gas borne contaminants by contacting the gas with the growth medium containing the growing plant to form a filtered gas; and
(C) exhausting the filtered gas back into the space.

2. The method of claim 1, wherein the subsurface member further including:
(3) an interior, a top and a bottom.

3. The method of claim 2, wherein the gas inlet is disposed in the bottom of the member and the gas outlet is disposed in the top of the member.

4. The method of claim 3, wherein the bottom includes a plurality of gas inlets disposed therein.

5. The method of claim 1, wherein the member is in the shape of a torus having a top half, a bottom half, at least one gas outlet and a plurality of gas inlet inlets disposed in the bottom half of the torus.

6. The method of claim 5, wherein the gas outlet is disposed in the top half of the torus.

7. The method of claim 5, wherein the gas inlets are disposed is a symmetrical pattern in the bottom half of the torus.

8. The method of claim 2, wherein the gas inlet is a continuous slit in the bottom half of the torus.

9. A gas filtering system comprising:
(A) a plant growing device containing;
(i) a growth medium;
(ii) a plant growing in the medium;
(B) a subsurface member including:
(i) a first gas inlet for pulling the gas into member and through the medium;
(ii) a first gas outlet for discharging the gas from the member;
(C) a fan unit including:
(i) a second gas inlet in fluid communication with the first gas outlet;
(ii) a second gas outlet for discharging the gas into the space; and
(iii) a fan for drawing gas from second gas inlet and exhausting gas out the second gas outlet.

10. The system of claim 9, the system further comprising:
(D) an electronic unit including:
(i) a circuit board;
(ii) an on/off switch;
(iii) indicator lights.

11. The system of claim 10, the system further comprising:
(E) a moisture sensor placed subsoil below the bottom of the subsurface member.

12. The system of claim 9, wherein the subsurface member further including:
(iii) an interior, a top and a bottom.

13. The system of claim 12, wherein the gas inlet is disposed in the bottom of the member and the gas outlet is disposed in the top of the member.

14. The system of claim 13, wherein the bottom includes a plurality of gas inlets disposed therein.

15. The system of claim 9, wherein the member is in the shape of a torus having a top half, a bottom half, at least one gas outlet and a plurality of gas inlet inlets disposed in the bottom half of the torus.

16. The system of claim 15, wherein the gas outlet is disposed in the top half of the torus.

17. The system of claim 15, wherein the gas inlets are disposed is a symmetrical pattern in the bottom half of the torus.

18. The system of claim 12, wherein the gas inlet is a continuous slit in the bottom half of the torus.

19. A gas filtering system comprising:
(A) a member to be placed below a growth meduim surface including:
(i) a first gas inlet in fluid communication through the medium to a space; and
(ii) a first gas outlet;
(B) a fan unit connected to the member including:
(i) a second gas inlet in fluid communication with the first gas outlet;
(ii) a second gas outlet in fluid communication with the space; and
(iii) a fan for drawing gas from the space through the medium into and out of the member and into and out of the fan unit back into the space.

20. The system of claim 9, the system further comprising:
(D) an electronic unit including:
(i) a circuit board;
(ii) an on/off switch;
(iii) indicator lights; and
(E) a moisture sensor placed subsoil below the bottom of the subsurface member.
